(19) United States
(12) Patent Application Publication
(10) Pub. No.: US 2007/0012408 A1
(43) Pub. Date: Jan. 18, 2007

(54) Mobile block set of a curtain

(76) Inventor: Li-Ming Cheng, Kaohsiung City (TW)

Correspondence Address: BIRCH STEWART KOLASCH & BIRCH, PO BOX 747, FALLS CHURCH, VA, 22040-0747, US

(21) Appl. No.: 11/180,700

(22) Filed: Jul. 14, 2005

(51) Int. Cl. E06B 9/00

(52) U.S. Cl. 160/178.1 R

(57) ABSTRACT

The present invention provides a mobile block set, which mainly includes an inside block, at least one interconnecting block and an outside block. The inside block, the interconnecting block and the outside block are combined and connected to one another by using a mounting element, whereby the mobile block set is assembled to the side of a upper rail, a lower rail, or the housing of a remote power-driven device of the curtain. The present invention changes the entire length of each mobile block sets, causes the entire lengths of the upper rail, the lower rail and the remote power-driven device (all include mobile block set) to meet the requirement of the width of the window, and provides the high convenience of the installation of curtain.

### FIELD OF THE INVENTION

The present invention relates to a mobile block set of a curtain, and more particularly to a mobile block set which can be assembled to the side of a upper rail, a lower rail or a remote power-driven device of the curtain, and can meet the requirement of the window by changing the entire length of mobile block sets if necessary.

### BACKGROUND OF THE INVENTION

Nowadays, typical curtains, such as a Venetian blind curtain, a shade curtain, etc. in the market, mainly includes an upper rail located at the upper location thereof and a lower rail located at the lower location thereof, wherein the lower rail opposite to the upper rail. There is some space between the lower rail and the upper rail, thereby folding up and receiving slats of curtain. The curtain further provided with cords, a remote power-driven device, or other components, thereby controlling the folding/receiving or opening/closing the slats of curtain, and further prevent from the light and having a function of decoration.

Furthermore, according to the curtains sold in the market recently, a consumer needs to install most of the curtains by himself after buying the curtain. In other words, general consumer can install the curtain at a window of a house by himself. However, the curtains which are installed by the consumer and sold in the market only have some normal sizes. Although the consumer measures the width of the window of the house in advance and then buys the curtain with specific size, it is still possible that specific size of the curtain is different from the width of the window. For example, the widths of the upper rail, the lower rail and the slats of the curtain are more than that of the window. Thus, when the consumer installs the curtain by himself, the consumer is possibly requested to cut the width of the slats in accordance with the width of the window. Although the slats of the above-mentioned curtain are cut to meet the requirement of the width of the window, it is not easy that general consumer directly cut the lengths of the upper rail and the lower rail. The consumer still demands that the seller of curtain assist the consumer to cut the lengths of the upper rail and the lower rail, and subsequently the consumer can successfully install the curtain. Thus, the installation process of the curtain is very convenient when the consumer installs the curtain by himself. Furthermore, after the upper rail and the lower rail of the curtain are cut, it is easy to damage the whole structure and appearance of the curtain and to further affect the beauty of the house.

### SUMMARY OF THE INVENTION

It is an object of the present invention to provide a mobile block set of a curtain which can cause the entire lengths of the upper rail, the lower rail of the curtain or the remote power-driven device disposed on the upper rail to meet the requirement of the width of the window by changing the entire length of mobile block sets.

In order to achieve the foregoing objects, the present invention provides a mobile block set of a curtain comprising:
an inside block comprising a connecting portion formed on one side thereof and provided with a screw hole;
at least one interconnecting block disposed on the other side of the inside block opposite to the connecting portion and provided with a through hole corresponding to the screw hole of the inside block;
an outside block disposed on one side of the interconnecting block opposite to the inside block and provided with a through hole corresponding to the screw hole of the inside block; and
a mounting element comprising a screw portion formed at one end thereof and a head formed at the other end thereof, wherein the end with the screw portion of the mounting element passes through the through hole of the outside block and the through hole of the interconnecting block, and the screw portion at the other end is screwedly connected to the screw hole of the inside block.

According to the structure of the mobile block set, the mobile block set is assembled to a side of a upper rail of the curtain, a side of a lower rail of the curtain, or a side of the housing of a remote power-driven device. The inside block, the interconnecting block and the outside block can be assembled or disassembled to one another by using a mounting element, thereby changing the entire length of mobile block sets if necessary. Thus, when the upper rail, the curtain, or the remote power-driven device of the curtain will be installed at the window, the consumer can properly decrease the number of mobile block sets, thereby causing the entire lengths of the upper rail, the lower rail and the remote power driven device (all include mobile block sets) to meet the requirement of the width of the window so as to provide the high convenience that the consumer can install the curtain by himself, and prevent affecting the whole appearance of the upper rail and the lower rail.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded perspective view of a mobile block set according to an embodiment of the prevent invention.

FIG. 2 is a cross sectional view of a mobile block set showing the mobile block set installed at a curtain.

FIG. 3 is an exploded perspective view of a mobile block set according to another embodiment of the prevent invention.

FIG. 4 is an exploded perspective view of a mobile block set according to a further embodiment of the prevent invention.

FIG. 5 is a perspective view of a mobile block set showing the mobile block set installed at a curtain according to an embodiment of the prevent invention.

FIG. 6 is a perspective view of a mobile block set showing the mobile block set installed at a curtain according to another embodiment of the prevent invention.

FIG. 7 is a perspective view of a mobile block set showing the mobile block set installed at a curtain according to a further embodiment of the prevent invention.

FIG. 8 is a cross sectional view of a mobile block set showing the length of the mobile block set to be changed.

### DESCRIPTION OF THE PREFERRED EMBODIMENTS

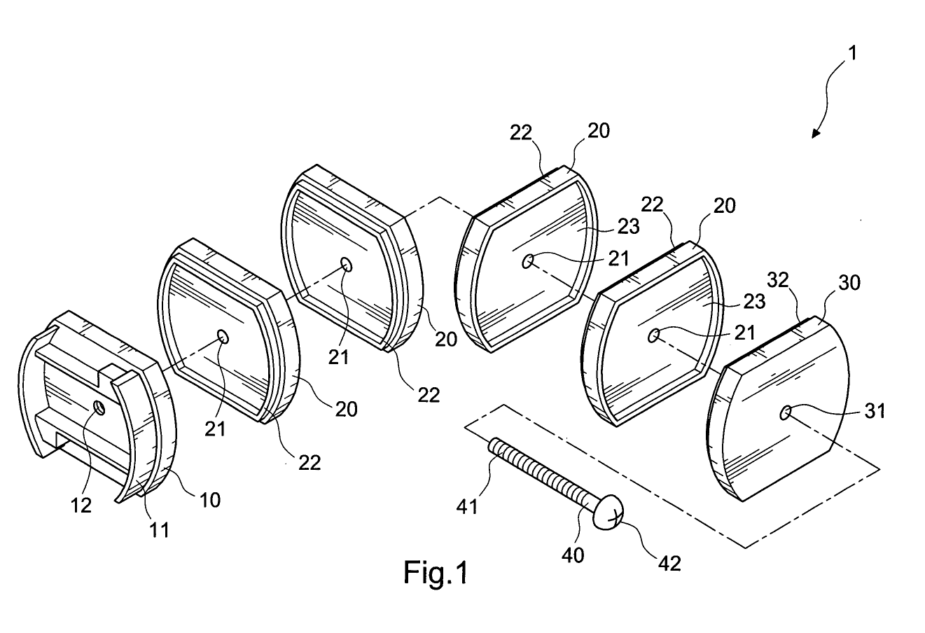

Referring to FIG. 1, it depicts a mobile block set 1 according to an embodiment of the prevent invention. The mobile block set 1 includes an inside block 10, an outside block 30 and at least one interconnecting block 20 which is combined and connected between the inside block 10 and the outside block 30. The inside block 10, the interconnecting block 20 and the outside block 30 are combined and connected to one another by using a mounting element 40, thereby facilitating the assembly or disassembly of the mobile block set 1.

The inside block 10 includes a connecting portion 11 formed on a side thereof and connected to one side of a housing of a remote power-driven device or an upper rail and an lower rail of the curtain each other, and the inside block 10 is provided with a screw hole 12.

The interconnecting block 20 is disposed on the other side of the inside block 10 opposite to the connecting portion 11. When there is a plurality of interconnecting blocks 20, the sizes and structures of the interconnecting blocks 20 can be the same as one another. Also, each interconnecting block 20 is provided with a through hole 21 corresponding to the screw hole 12 of the inside block 10.

The outside block 30 is disposed on one side of the interconnecting block 20 opposite to the inside block 10, and the outside block 30 is provided with a through hole 31 corresponding to the screw hole 12 of the inside block 10.

The mounting element 40 includes a screw portion 41 formed at one end thereof and a head 42 formed at the other end thereof. The head 42 is turned by a flat head screwdriver, a cross head screwdriver, a hex-key wrench or other tools, and thus the end with the screw portion 41 of the mounting element 40 passes through the through hole 31 of the outside block 30 and the through hole 21 of the interconnecting block 20 in sequence, and the screw portion 41 is screwedly connected to the screw hole 12 of the inside block 10, whereby the mounting element 40 forces the inside block 10, the interconnecting block 20 and the outside block 30 to combine and connect to one another.

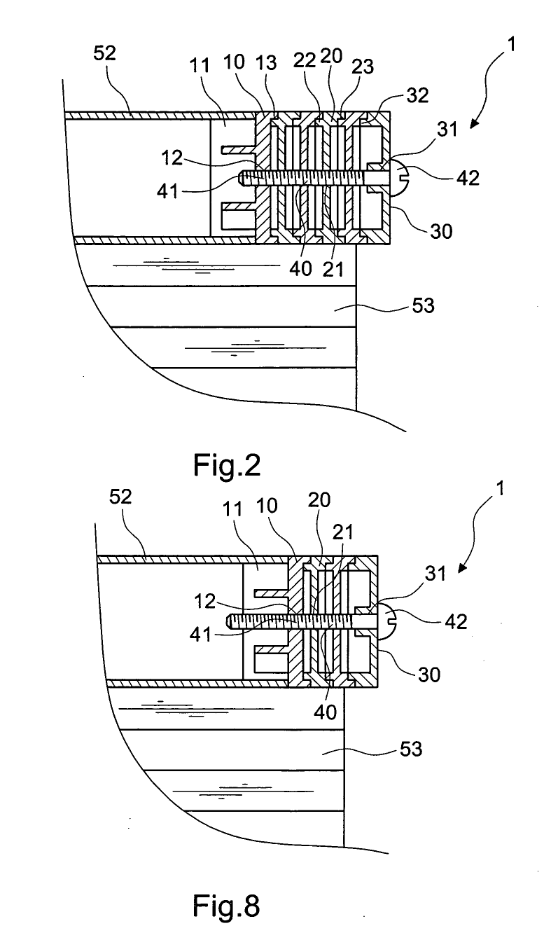

Referring to FIG. 2, the interconnecting block 20 includes a snapping flange 22 formed at one side thereof facing the inside block 10 and further includes a positioning groove 23 formed at the other side thereof and corresponding to the snapping flange 22, whereby the interconnecting blocks 20 can be snapped to one another. Furthermore, the inside block 10 includes a positioning groove 13 formed on the other side thereof opposite to the connecting portion 11 for snapping the snapping flange 22 of the adjacent interconnecting block 20 into the positioning groove 13. The outside block 30 includes a snapping flange 32 formed on the side thereof which is opposite to the interconnecting block 20, and the snapping flange 32 can be snapped into the positioning groove 23 of the adjacent interconnecting block 20. Thus, The inside block 10, the interconnecting block 20 and the outside block 30 are not only combined and connected to one another by using the mounting element 40, but also preferably combined, connected and positioned by using the above-mentioned snapping flange and positioning groove.

The connecting portion 11 of the inside block 10 includes a protrudent portion extending from one side thereof and outwardly. Grooves are formed on the two sides of the upper rail, the lower rail or the side of the housing of the remote power-driven device of the curtain for connecting to the inside block 10, and the grooves are corresponding to the protrudent portion. Thus, the protrudent portion of the inside block 10 can be forced to insert into the grooves of the upper rail, the lower rail or the housing of the remote power-driven device of the curtain, whereby the inside block 10 can be certainly connected to the upper rail, the lower rail or the housing of the remote power-driven device of the curtain. Likewise, the protrudent portion and groove can be designed to interchange, i.e. the connecting portion 11 of the inside block 10 may include a groove, and the upper rail, the lower rail or the housing of the remote power-driven device of the curtain may include protrudent portions.

The above-mentioned inside block 10, the interconnecting block 20 and the outside block 30 are mainly combined and connected to the sides of the upper rail, the lower rail or the housing of the remote power-driven device of the curtain, and thus the shapes of the above-mentioned inside block 10, the interconnecting block 20 and the outside block 30 are corresponding to the sectional profile of the sides of the upper rail, the lower rail or the housing of the remote power-driven device of the curtain, wherein the above-mentioned inside block 10, the interconnecting block 20 and the outside block 30 can be designed to be various geometric shapes. Referring to FIG. 3, the shapes of the above-mentioned inside block 10a, the interconnecting block 20a and the outside block 30a can be rectangular sheet-shaped block. Otherwise, referring to FIG. 4, the shapes of the above-mentioned inside block 10b, the interconnecting block 20b and the outside block 30b can be long elliptic sheet-shaped block. Thus, when the mobile block set of the present invention is assembled to the sides of the upper rail, the lower rail or the housing of the remote power-driven device of the curtain, the mobile block set of the present invention meets the requirement of beauty and decoration.

Referring to FIG. 5, the mobile block set of the present invention is assembled to a shade curtain 50. The inside block 10, the interconnecting block 20 and the outside block 30 are combined and connected to one another in advance by using a mounting element 40, thereby forming the mobile block set 1 of the present invention. Then, a plurality of mobile block sets 1 of the present invention are respectively assembled to two sides of the upper rail 51 and the lower rail 52 of the curtain 50 by utilizing the design of the connecting portion 11 of the inside block 10.

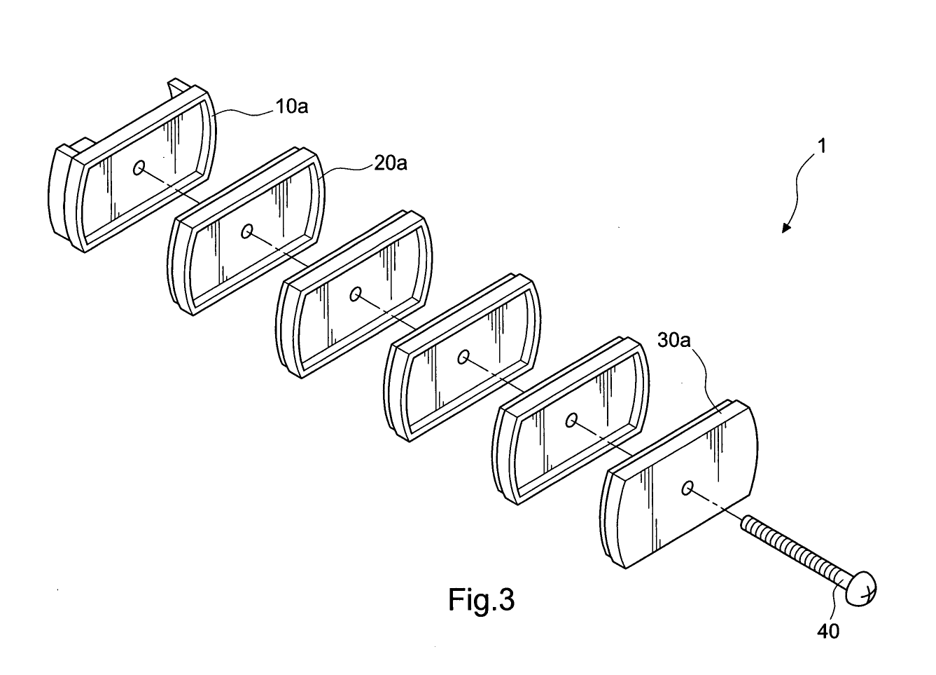

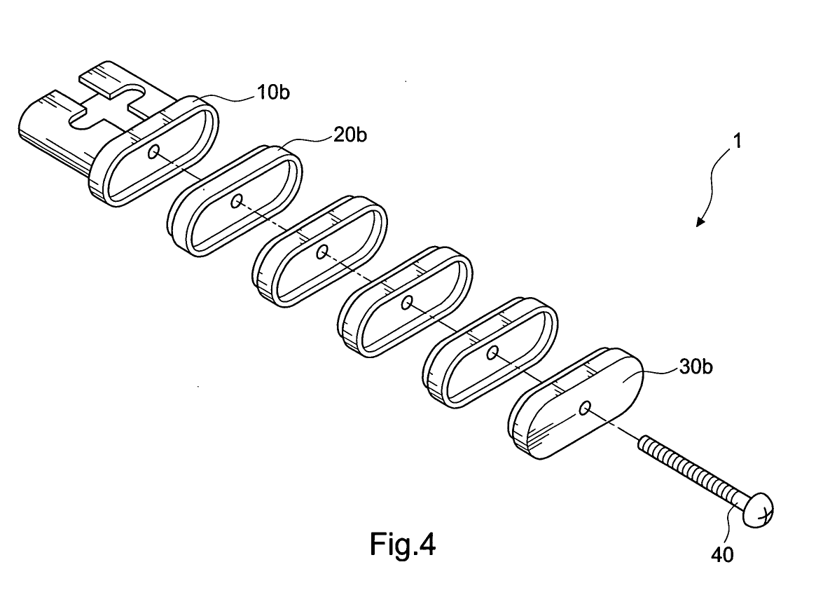

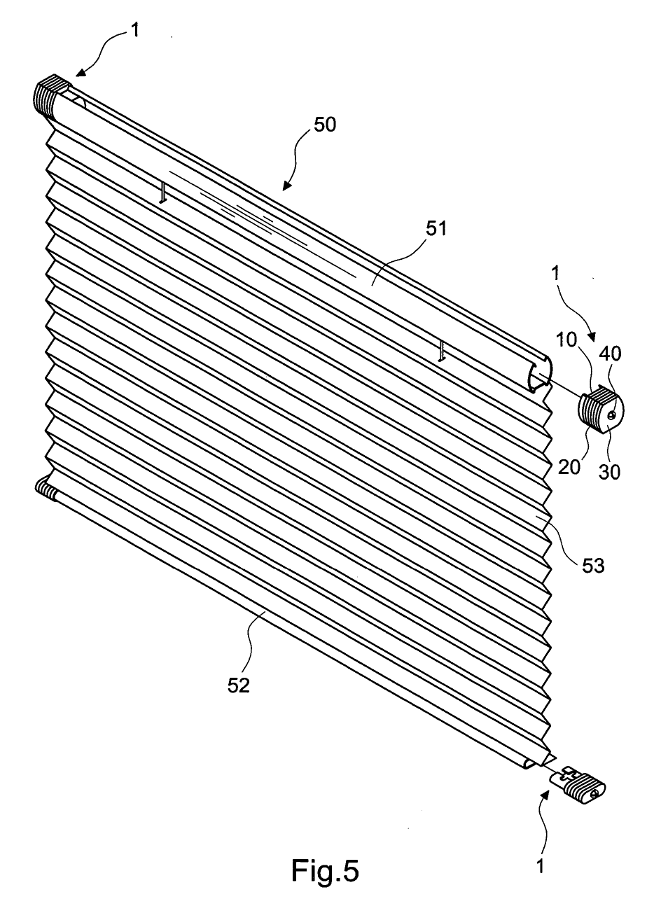

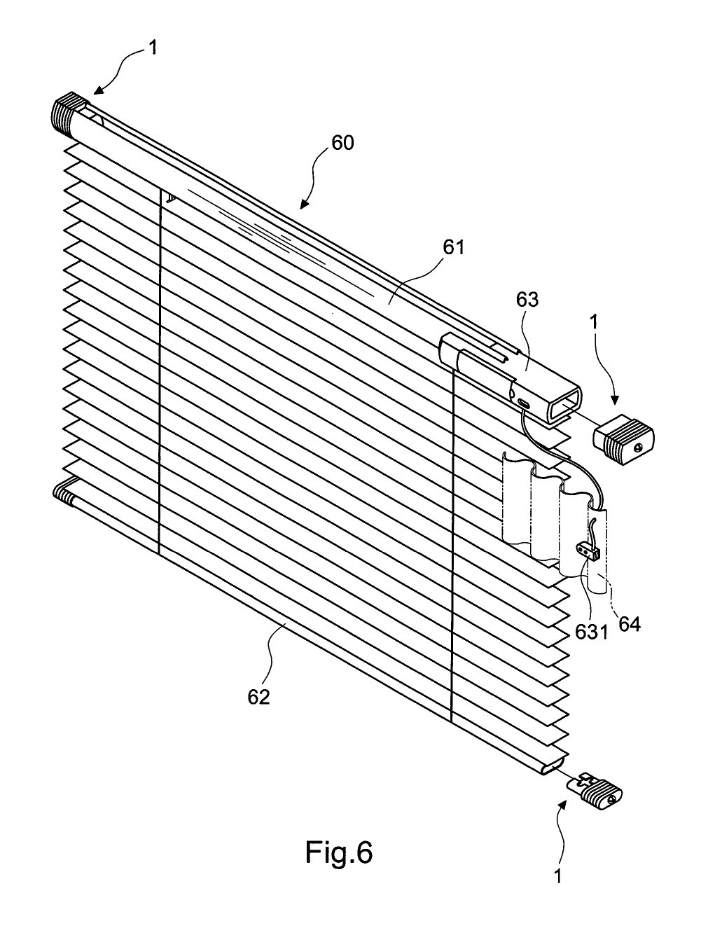

Furthermore, referring to FIG. 6, the mobile block set of the present invention is assembled to a Venetian blind curtain 60 with the remote power-driven device. When the curtain includes the remote power-driven device, mobile block sets 1 respectively assembled to one side of the upper rail 61 of the curtain 60, two sides of the lower rail 62 of the curtain 60, and one side of the housing of the remote power-driven device 63 disposed on the upper rail 61 of the curtain 60. Simultaneously, when the Venetian blind curtain 60 includes a cloth 64 disposed on the outside thereof, a signal receiver 631 of the remote power-driven device 63 can be disposed on the outside of the cloth 64.

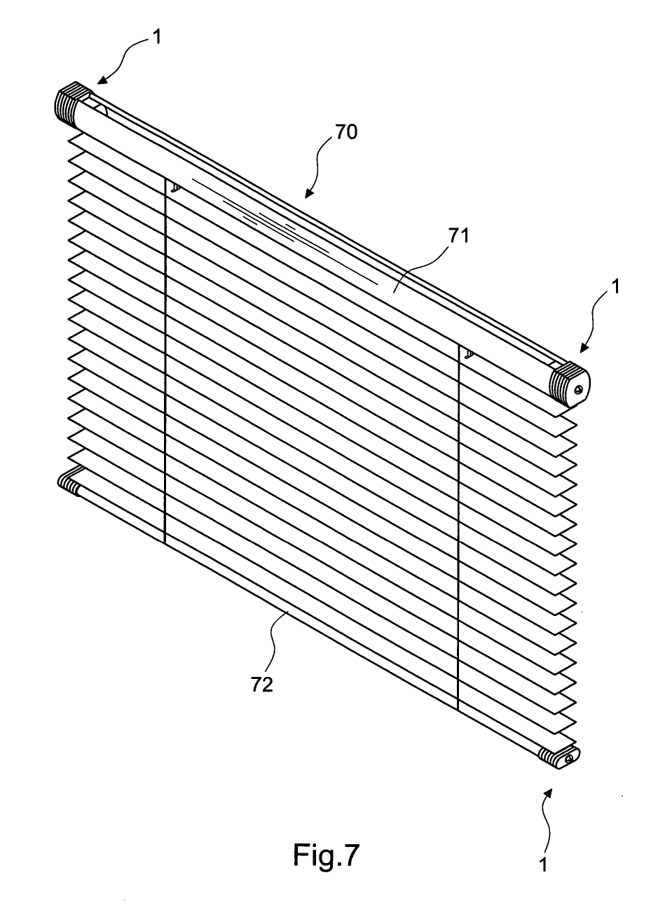

Furthermore, referring to FIG. 7, the mobile block set of the present invention is assembled to a Venetian blind curtain 70 without the remote power-driven device. When the curtain does not include the remote power-driven device, mobile block sets 1 respectively assembled to two sides of the upper rail 71 of the curtain 70 and two sides of the lower rail 72 of the curtain 70.

Thus, when the consumer want to buy a curtain, the consumer can measure the width of window in advance and then choose the curtain with proper standard size from the seller of the curtain. If the standard size of the curtain cannot match with the width of the window during choosing of the curtain, the consumer can choose the curtain whose the upper rail and lower rail include the mobile block sets 1, wherein the length of the curtain is longer than the width of the window, thereby facilitating the subsequent installation of the curtain. Referring to FIG. 5 again, the embodiment is described as follows:

When the consumer installs the curtain 50 at the window of the house by himself, the consumer can assemble the plurality of mobile block sets 1 to two sides of the upper rail 51 of the curtain 50 and two sides of the lower rail 52 of the curtain 50. During installation process of the curtain, the consumer cuts the width of the slats 53 in accordance with the width of the window of the house. As shown in FIG. 8, the consumer then assembles or disassembles the inside block 10, the interconnecting blocks 20 and the outside block 30 by using the mounting element 40, and properly decreases the number of the interconnecting blocks 20, thereby changing the length of each mobile block set 1 and causing the entire lengths of the upper rail 51 and the lower rail 52 (both include mobile block sets) to meet the requirement of the width of the window so as to finish the installation of the curtain 50.

As described above, the mobile block set of the curtain of the present invention is characterized in that during installation process of the curtain, the consumer assembles or disassembles the inside block 10, the interconnecting blocks 20 and the outside block 30 by using the mounting element 40, thereby changing the entire length of mobile block sets 1 if necessary and causing the entire lengths of the upper rail, the lower rail and the remote power-driven device (all include mobile block set) to meet the requirement of the width of the window. Thus, the upper rail and the lower rail are not requested to cut by the seller so as to prevent affecting the whole appearance of the curtain, provide the high convenience that the consumer can install the curtain by himself, and be a very good design.

Although the invention has been explained in relation to its preferred embodiment, it is not used to restrain the invention. It is to be understood that many other possible modifications and variations can be made by those skilled in the art without departing from the spirit and scope of the invention as hereinafter claimed.

What is claimed is:

1. A mobile block set of a curtain comprising:
an inside block comprising a connecting portion formed on one side thereof and provided with a screw hole;
at least one interconnecting block disposed on the other side of the inside block opposite to the connecting portion and provided with a through hole corresponding to the screw hole of the inside block;
an outside block disposed on one side of the interconnecting block opposite to the inside block and provided with a through hole corresponding to the screw hole of the inside block; and
a mounting element comprising a screw portion formed at one end thereof and a head formed at the other end thereof, wherein the end with the screw portion of the mounting element passes through the through hole of the outside block and the through hole of the interconnecting block, and the screw portion at the other end is screwedly connected to the screw hole of the inside block.

2. The mobile block set of a curtain according to claim 1, wherein the interconnecting block comprises a snapping flange formed at one side thereof facing the inside block and further comprises a positioning groove formed at the other side thereof and corresponding to the snapping flange, the inside block comprises a positioning groove formed on the other side thereof opposite to the connecting portion for snapping the snapping flange of the adjacent interconnecting block into the positioning groove, and the outside block comprises a snapping flange formed on the side thereof which is opposite to the interconnecting block and snapped into the positioning groove of the adjacent interconnecting block.

3. The mobile block set of a curtain according to claim 2, wherein the connecting portion is a protrudent portion.

4. The mobile block set of a curtain according to claim 3, wherein the connecting portion is a groove.

5. The mobile block set of a curtain according to claim 1, wherein the connecting portion is a protrudent portion.

6. The mobile block set of a curtain according to claim 5, wherein the connecting portion is a groove.
